(19) United States
(12) Patent Application Publication
(10) Pub. No.: US 2010/0032276 A1
(43) Pub. Date: Feb. 11, 2010

(54) KEY SHEET

(76) Inventor: FUMITAKA ARAI, Tokyo (JP)

Correspondence Address: CERMAK KENEALY VAIDYA & NAKAJIMA LLP, 515 EAST BRADDOCK RD SUITE B, Alexandria, VA, 22314, US

(21) Appl. No.: 12/511,159

(22) Filed: Jul. 29, 2009

(30) Foreign Application Priority Data
Aug. 6, 2008 (JP) 2008-202778

(51) Int. Cl. H01H 1/10

(52) U.S. Cl. 200/513

(57) ABSTRACT

Provided is a key sheet which can effect reliable fixation inside a casing without occupying a large space, and includes key tops having large operating surfaces. A sheet surface of a base sheet is set substantially the same in size as a projection surface in a depressing direction of a key top group, and a frame-shaped elastic fixation portion is formed at an outer edge of the base sheet. Thus, a mounting space for a key sheet inside a casing can be contained within a range of the projection surface in the depressing direction of the key top group, and the key sheet can be firmly fixed to a circuit board. The key top group is the same in size as the base sheet. Thus, the key sheet including key tops having large operating surfaces can be realized.

### BACKGROUND OF THE INVENTION

1. Field of the Invention

The present invention relates to a key sheet for a pushbutton switch, the key sheet being used in operating portions of various electronic apparatuses such as a mobile phone, a personal digital assistant (PDA), a car navigation apparatus, and a car audio apparatus.

2. Description of the Related Art

For use in the mobile phone as an example of an electronic apparatus, there is known a pushbutton switch in which key tops subjected to depressing operation are exposed through an operational opening formed in a casing thereof. A key sheet constituting a part of this pushbutton switch is used while being mounted on a circuit board having contact switches. As illustrated in FIGS. 17 and 18, in such a conventional key sheet described in, for example, JP 2008-16220 A, in a state in which key tops 4 are exposed through an operational opening 2a of a casing 2 of the mobile phone, an outer edge of a base sheet 5 protruding outward with respect to the key tops 4 is incorporated and sandwiched in a depressed state between the casing 2 and a projection 6a provided on a circuit board 6. That is, a key sheet 3 is assembled to the mobile phone by sandwiching the base sheet 5.

However, when components incorporated inside the casing of the apparatus are close-spaced in accordance with reduction in size and thickness of the electronic apparatus, a redundant space is eliminated. Thus, a sandwiching structure for solely retaining the key sheet is reexamined, and it becomes difficult to incorporate the key sheet by sandwiching the outer edge of the base sheet unlike the conventional key sheet.

Further, in order to facilitate input operation, there is a trend that front surfaces of the key tops subjected to the depressing operation are made larger, and design is made such that the key tops are provided to an end portion of the front surface of the mobile phone.

### SUMMARY OF THE INVENTION

The present invention has been made in view of the above-mentioned change in technology and trend. It is therefore an object of the present invention to provide a key sheet which can effect reliable fixation inside a casing without involving a large space, and includes key tops having large operating surfaces.

In order to achieve the above-mentioned object, the present invention is configured as follows.

A key sheet which is mounted on a circuit board having a contact switch so as to serve as a pushbutton switch includes: a plurality of key tops which are subjected to depressing operation in a depth direction in plan view; and a base sheet which is flexible and on which the plurality of key tops are placed. In the key sheet, the plurality of key tops are provided so that the plurality of key tops cover the base sheet and the base sheet hides behind the plurality of key tops in plan view at an outer edge on at least one end side of the key sheet, and an elastic fixation portion to be fixed to the circuit board is provided on a back surface side of the base sheet.

The key tops are provided so that the key tops cover the base sheet and the base sheet hides behind the key tops in plan view at the outer edge on at least one end side of the key sheet, and hence it is unnecessary to provide a part of the base sheet protruding outward with respect to the key tops at the outer edge on at least one end side thereof. Thus, it is possible to set a size in a plane direction of the key sheet to be smaller, or to set a size of the key tops to be larger.

Further, at the outer edge on at least one end side of the key sheet, the elastic fixation portion to be fixed to the circuit board is provided on the back surface side of the base sheet, and hence it is unnecessary to sandwich the key sheet at the part of the base sheet protruding with respect to the outer edges of the key tops. Thus, it is possible to fix the key sheet inside the casing by the elastic fixation portion.

The elastic fixation portion can undergo elastic deformation in a depressing direction, that is, in the depth direction in plan view of the key sheet, and can undergo compression deformation at the time of depressing operation. Therefore, it is possible to reduce depression load causing deflection of the key sheet. Further, when the contact switch such as a belleville spring having a click feeling is depressed, it is possible to satisfactorily transmit its click feeling. Note that, the elastic fixation portion is provided on the back surface side of the base sheet. According to circumstances, the elastic fixation portion is directly fixed to the back surface of the base sheet, or indirectly fixed to the back surface of the base sheet through the intermediation of a shape retaining sheet made of hard resin material described later.

At the entire outer edge of the key sheet, for example, at an outer edge consisting of four sides of a rectangular key sheet in plan view, the key tops cover the base sheet. As a result, there can be realized a key sheet in which a total size of front surfaces of the plurality of key tops is set to be larger than a size of the sheet surface of the base sheet.

This key sheet can include a pusher. In the key sheet, the pusher for depressing the contact switch correspondingly to at least one of the plurality of key tops situated on the one end side of the key sheet can be provided near a center of the base sheet while being shifted from a center of the at least one of the plurality of key tops.

The key tops forming the outer edge of the key sheet are provided near the center of the base sheet while being shifted from the centers of the key tops, and thus it is possible to decrease depression load to thereby effectively transmit the depression load to the contact switch. Further, when the contact switch such as a belleville spring which generates a click feeling is depressed, it is possible to satisfactorily transmit its click feeling to an operator. In such a key sheet, substantially the entire base sheet is deflected to thereby effect input operation in many cases when the key tops are subjected to depressing operation. The deflection dimension becomes larger on the center side of the base sheet than on the outer edge side thereof, and hence a gap between the circuit board and the key sheet becomes smaller on the center side of the base sheet than on the outer edge side thereof. Further, the elastic fixation portion is situated below the key tops described above, and the key tops turn using the elastic fixation portion as a fulcrum. Therefore, in comparison with a case where the pusher is provided at the center of at least one of the key tops, depressing on the belleville spring is effected more smoothly in a case where the pusher is provided away from the elastic fixation portion, that is, near the center of the base sheet.

According to circumstances, the pusher, which is provided on the back surface side of the base sheet, is directly fixed to the back surface of the base sheet, or indirectly fixed to the back surface of the base sheet through the intermediation of another member such as a shape retaining sheet.

Further, the elastic fixation portion can be formed of a double-faced tape, which has adhesiveness on its front surface and includes a foam layer as a base portion. The elastic fixation portion is formed of such a double-faced tape, and hence the foam layer is compressed at the time of depressing operation on the key tops. As a result, the foam layer can undergo deformation, and it is possible to reduce depression load causing deflection of the key sheet. Further, when the contact switch which generates a click feeling is depressed, it is possible to satisfactorily transmit its click feeling to an operator.

The elastic fixation portion can be formed along an outer edge of the base sheet into a frame shape. The elastic fixation portion is formed along the outer edge of the base sheet into a frame shape, and hence it is possible to firmly fix the key sheet onto the circuit board. Further, at the time of depressing operation, substantially the entire base sheet is deflected. As a result, it is possible to reduce depression load, and to increase depression operativity.

Further, in the key sheet, a shape retaining sheet which is made of hard resin and suppresses deflection of the base sheet can be provided on a back surface of the base sheet.

When the base sheet is formed of a soft resin film which is flexible and easily deformed, or made of rubber-like elastic material, a separate shape retaining sheet is provided. As a result, it is possible to retain a shape of the key sheet, and to facilitate handling at the time of assembling to the electronic apparatus.

The shape retaining sheet can be fixed to the base sheet at the outer edge of the shape retaining sheet, or the shape retaining sheet and the base sheet can be fixed to each other while corresponding to the key tops. When the shape retaining sheet is fixed to the base sheet at the outer edge of the shape retaining sheet, it is possible to retain the shape of the key sheet by the entire surface of the shape retaining sheet, and to fix the shape retaining sheet and the base sheet to each other while corresponding to the key tops. When fixation is effected while corresponding to the key tops, it is possible to suppress deflection phenomenon which occurs on the center side of the base sheet.

Insulating holes, which insulate stress acting in a surface direction of the shape retaining sheet, can be formed in the shape retaining sheet so as to pass through the shape retaining sheet in a sheet thickness direction thereof. Provision of the insulating holes can facilitate deflection of the shape retaining sheet in the depressing direction, and decrease depression load. Further, when the contact switch which generates a click feeling is depressed, it is possible to satisfactorily transmit its click feeling to an operator.

The key tops have, at one end thereof, a protrusion protruding outward with respect to an end portion of the base sheet. With this configuration, it is possible to set a size of the front surface of the key top group to be larger than a size of the sheet surface of the base sheet, and to realize the key sheet which facilitates depressing operation.

A resin film parallel to the plurality of key tops can constitute one part of the outer edge of the key sheet, and at another part of the outer edge thereof, the base sheet can have a protruding piece protruding outward with respect to the plurality of key tops. With this configuration, when the key sheet is assembled to the apparatus, by abutting the resin film, which constitutes the one part of the outer edge of the key sheet, against the casing and the like, the key sheet can be positioned, to thereby be placed on and assembled to the circuit board. Further, the key sheet can be fixed by sandwiching, in the casing and the like, the protruding piece of the base sheet at another part of the outer edge thereof.

According to the present invention, there can be provided a key sheet which can effect reliable fixation inside a casing without occupying a large space, and includes key tops having large operating surfaces.

Further, there can be provided an electronic apparatus which is designed such that the key tops are situated at an outer edge thereof.

The present invention is not limited to the above description. The advantages, features, purposes of the present invention become apparent from the following description made with reference to the attached drawings. Further, it should be understood that all appropriate changes within such a scope as not to depart from the gist of the present invention are included in the scope of the present invention.

### BRIEF DESCRIPTION OF THE DRAWINGS

In the accompanying drawings:

FIG. 1 is a plan view of a key sheet according to a first embodiment;

FIG. 2 is a sectional view taken along the line II-II of FIG. 1;

FIG. 3 is a bottom view of the key sheet according to the first embodiment;

FIG. 4 is a sectional view illustrating a state in which the key sheet according to the first embodiment is mounted to an electronic apparatus;

FIG. 5 is a sectional view of a key sheet according to a second embodiment, and corresponds to FIG. 2;

FIG. 6 is a bottom view of the key sheet according to the second embodiment;

FIG. 7 is a sectional view illustrating a state in which the key sheet according to the second embodiment is mounted to an electronic apparatus;

FIG. 8 is a sectional view of a key sheet according to a third embodiment, and corresponds to FIG. 2;

FIG. 9 is a bottom view of the key sheet according to the third embodiment;

FIG. 10 is a sectional view illustrating a state in which the key sheet according to the third embodiment is mounted to an electronic apparatus;

FIG. 11 is a plan view of a key sheet according to a fourth embodiment;

FIG. 12 is a sectional view taken along the line XII-XII of FIG. 11;

FIG. 13 is a bottom view of the key sheet according to the fourth embodiment;

FIG. 14 is a sectional view illustrating a state in which the key sheet according to the fourth embodiment is mounted to an electronic apparatus;

FIG. 15 is a plan view of a key sheet according to a fifth embodiment;

FIG. 16 is a sectional view taken along the line XVI-XVI of FIG. 15;

FIG. 17 is an outward appearance view of a mobile phone provided with a conventional key sheet; and

FIG. 18 is a sectional view taken along the line XVIII-XVIII of FIG. 17.

### DETAILED DESCRIPTION OF THE PREFERRED EMBODIMENTS

Hereinafter, embodiments of the present invention are described with reference to the drawings. In the drawings, the reference symbols denote portions and components of the present invention. Note that, the portions and components common to the embodiments are denoted by the same reference symbols, and redundant description thereof is omitted.

In the following embodiments, the present invention is described as applied to a key sheet to be used in a mobile phone 1 as an “electronic apparatus”. In particular, the present invention is described as applied to a key sheet, in which a plurality of key tops are exposed through an operational opening 2a with no partition frame which is formed in a casing 2 of the mobile phone 1.

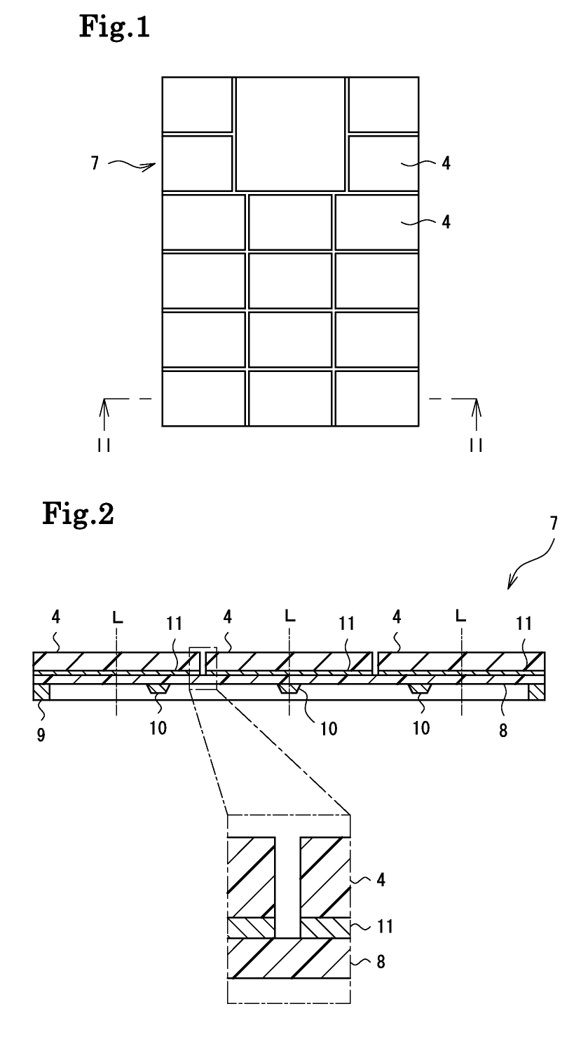

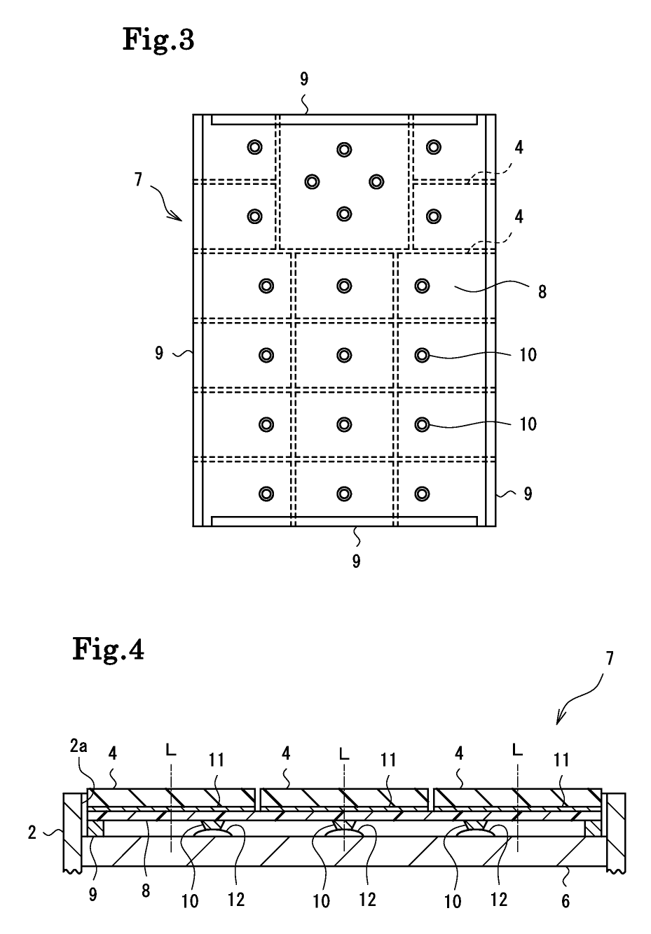

First Embodiment (FIGS. 1 to 4): FIGS. 1 to 4 illustrate a key sheet 7 according to a first embodiment of the present invention. FIG. 1 is a plan view of the key sheet 7, and FIG. 2 is a sectional view of the key sheet 7 taken along the line II-II of FIG. 1. FIG. 3 is a bottom view of the key sheet 7, and FIG. 4 is a sectional view of the mobile phone 1 provided with the key sheet 7. The key sheet 7 includes key tops 4, a base sheet 8, elastic fixation portions 9, and pushers 10.

The key tops 4 are regions subjected to depressing operation by fingers. In view of a satisfactory operating feeling, the key tops 4 are made of hard resin and formed into a rectangular shape in plan view in many cases. In this embodiment, seventeen key tops 4 are provided and form a key top group having a rectangular outer periphery. On the front surfaces of the key tops 4, there are provided decorations including numbers, characters, etc. in the form of print layers, coating layers, or the like. The back surfaces on the opposite side of the front surfaces are fixed to the base sheet 8 by an adhesive. This adhesive forms adhesive layers 11. Note that, the decorations in the form of print layers, coating layers, or the like can be provided in between the adhesive layers 11 and the back surfaces of the key tops 4 or on the front surface or the back surface of the base sheet 8.

The base sheet 8 is a member serving as a substrate connecting the plurality of key tops 4. The base sheet 8 is a flat flexible sheet made of resin film or rubber-like elastic material, and is formed to have a rectangular outer periphery substantially equivalent to the outer periphery of the key top group in plan view. That is, a size of the sheet surface of the base sheet 8 in plan view is the same as that of the projection surface of the key top group in a depth direction.

The elastic fixation portions 9 are members which are stuck onto the back surface of the base sheet 8 at an outer edge on one end side of the key sheet 7 and fixed to a front surface of a circuit board 6. It suffices that the elastic fixation portions 9 have surfaces fixative with respect to the circuit board 6. However, in view of easy formation, it is preferred that the elastic fixation portions 9 be formed of a double-faced tape, and more preferred that they be formed of a double-faced tape 9, which has adhesiveness on its front surface and includes a foam layer as a base portion. Provision of the foam layer realizes softness and allows large deflection, and hence it is easy to perform depressing operation on the key tops 4 formed on the elastic fixation portions 9 as described above. In this embodiment, the double-faced tape 9 is formed as a frame extending along the outer periphery of the base sheet 8, and its outer periphery is formed to be substantially flush with the key tops 4 and the base sheet 8.

The pushers 10 are portions for depressing belleville springs 12 as contact switches to be fixed onto the back surface of the base sheet 8 and arranged on the front surface of the circuit board 6. The pushers 10 are made of resin, and formed into a truncated-cone shape. In this embodiment, the pushers 10, which correspond to the key tops 4 in left and right two files among the key tops 4 aligned substantially in three files, are fixed near the center of the base sheet 8 while being shifted from the centers of the key tops 4. That is, as illustrated in FIG. 2, while the pushers 10 corresponding to the key tops 4 in the center file are fixed at positions indicated by one of center lines L of the key tops 4, the pushers 10 corresponding to the key tops 4 in the left and right files are fixed near the center of the base sheet 8 with respect to positions indicated by the center lines L of the key tops 4.

Next, materials of components constituting the key sheet 7 are described.

It is preferred that the key tops 4 be made of hard resin such as a thermoplastic resin or a reactive curing resin or metal from the viewpoint of the requisite performance such as mechanical strength, durability, and reduction in weight. Examples of the resin include a polycarbonate resin, a polymethyl methacrylate resin, a polypropylene resin, a polystyrene resin, a polyacrylic copolymer resin, a polyolefin resin, an acrylonitrile-butadiene-styrene resin, a polyester resin, an epoxy resin, a polyurethane resin, a polyamide resin, and a silicone resin. Of those hard resins, taking workability into consideration, the polycarbonate resin, the polymethyl methacrylate resin, the polyacrylic copolymer resin, and the acrylonitrile-butadiene-styrene resin are preferable, and taking transparency into consideration, the polycarbonate resin, the polymethyl methacrylate resin, and the polyacrylic copolymer resin are preferable.

Examples of the metal include aluminum and stainless steel. Apart from the hard resins and metal, a rubber-like elastic material such as a silicone rubber and a thermoplastic elastomer can also be used.

In this embodiment, in some cases, the base sheet 8 is required to be made of hard resin having rigidity for the purpose of maintaining a shape retaining property of the key sheet 7 while having flexibility. Further, in the case where such the rigidity is not attained but only durability enough for repeated use is necessary, the base sheet 8 is in some cases required to be made of soft resin or the rubber-like elastic material.

Examples of such a resin film include the following materials in the form of a unitary material or a composite material: a polyurethane resin film, a polyethylene resin film, a polypropylene resin film, a polyamide resin film, a polyvinyl chloride resin film, a polycarbonate resin film, an acrylonitrile-butadiene-styrene resin film, a polyethylene terephthalate resin film, a polybutylene terephthalate resin film, a polyphenylene oxide resin film, a polyphenylene sulfide resin film, a polyphenylene ether resin film, a denatured polyphenylene ether resin film, a polyketone resin film, and a liquid crystal polymer film. Among those, the polyamide resin film, the polyurethane resin film, the polyvinyl chloride resin film, etc., which are relatively thin, flexible, and free from rupture, are suitable as a soft resin film. A thermoplastic resin film is softened or melted by heating to allow firm fixation to another member.

In addition, examples of the rubber-like elastic body include, other than silicone rubber, thermoplastic elastomers such as styrene, ester, urethane, olefin, amide, butadiene, ethylene-vinyl acetate, vinyl chloride, fluoro carbon rubber, isoprene, and chlorinated polyethylene elastomers.

It is preferred that each of the elastic fixation portions 9 be formed of a double-faced tape in which a pressure-sensitive adhesive layer made of pressure-sensitive adhesive is formed on a front surface of a flexible base portion which is easily compressed. It is more preferred that such base portion of the double-faced tape is constituted by a foam layer having cushioning property. However, a soft material such as an elastomer can also be used. As a material having more flexible structure as a foam layer, there are exemplified, other than a synthetic rubber such as silicone rubber, thermoplastic elastomers such as styrene, ester, urethane, olefin, amide, butadiene, ethylene-vinyl acetate, vinyl chloride, fluorine, isoprene, and chlorinated polyethylene elastomers. As the pressure-sensitive adhesive, exemplified are acrylic, synthetic rubber, and silicone pressure-sensitive adhesives.

For the pushers 10, preferred is a hard resin out of a thermoplastic resin, a thermosetting resin, a photo-curable resin, and the like, from the viewpoint of the requisite performance such as mechanical strength, durability, and reduction in weight. Examples of the hard resin include an acrylate resin, a polycarbonate resin, a polyethylene terephthalate resin, a polymethyl methacrylate resin, a polypropylene resin, a polystyrene resin, a polyacrylic copolymer resin, a polyolefin resin, an acrylonitrile-butadiene-styrene resin, a polyester resin, an epoxy resin, a polyurethane resin, a polyamide resin, and a silicone resin. The photo-curable resin may include any of an ultraviolet curable type, a visible light curable type, and a electron beam curable type.

The adhesive layers 11 are formed of an adhesive such as a resin, a wax, or a rubber, which have mechanical strength and durability. Examples of those materials include a polyacrylic type, vinyl chloride type, polyester type, or polyurethane type material. It is desirable to use a hot-melt adhesive or the like, which is a solvent dilution type and a heat adhesion type adhesive, on which highly precise printing can be performed, and which is brought into a solid state through evaporation of a solvent after being applied to an object to be applied and is free from dripping, and which facilitates maintaining of the initial print form. Further, it is preferred to use a thermal softening type adhesive, which is relatively free from deformation of the adhesive layers 11 in an adhesion process. A photo-curing or moisture-curing liquid adhesive can be also used.

A manufacturing method for the key sheet 7 is described. First, the key tops 4 are molded by injection molding. After decorations are provided on the front surface of the key tops 4, the adhesive layers 11 are formed on the entire back surfaces thereof. The key tops are fixed to the base sheet 8 through the intermediation of the adhesive layers 11, and then the pushers 10 are formed on the back surface of the base sheet 8. Finally, the double-faced tapes are stuck onto the end portions of the back surface of the base sheet 8. Thus, the key sheet 7 is obtained.

FIG. 4 illustrates a state in which the key sheet 7 thus obtained is assembled to the mobile phone 1.

Inside the casing 2 of the mobile phone 1, there is provided the circuit board 6 on which the belleville springs 12 are arranged, and the key sheet 7 fixed by the elastic fixation portions 9 is placed above the circuit board 6. Thus, a pushbutton switch is formed.

When the key tops 4 exposed through the operational opening 2a of the casing 2 are subjected to depressing operation, the entire base sheet 8 undergoes curving deformation and is deflected, and the pushers 10 depress the belleville springs 12 to thereby effect input.

In the key sheet 7, the size of the sheet surface of the base sheet 8 is set to be substantially the same as the size of the projection surface in a depressing direction of the key top group, and the frame-shaped elastic fixation portions 9 are formed at the outer edge of the base sheet 8. As a result, a mounting space for the key sheet 7 inside the casing 2 can be contained within a range of the projection surface in the depressing direction of the key top group, and the key sheet 7 can be firmly fixed to the circuit board.

Further, when the key tops 4 covering the base sheet 8 are depressed, the elastic fixation portions 9 undergo compression deformation, and hence it is possible to obtain a satisfactory click feeling with low depression load.

The elastic fixation portions 9 are formed along the outer edge of the base sheet 8 into a rectangular frame shape, and block the front surface of the circuit board 6 from an outside of the key sheet 7. As a result, it is possible to prevent water and dust from the outside of the key sheet 7 from entering the front surface of the circuit board 6.

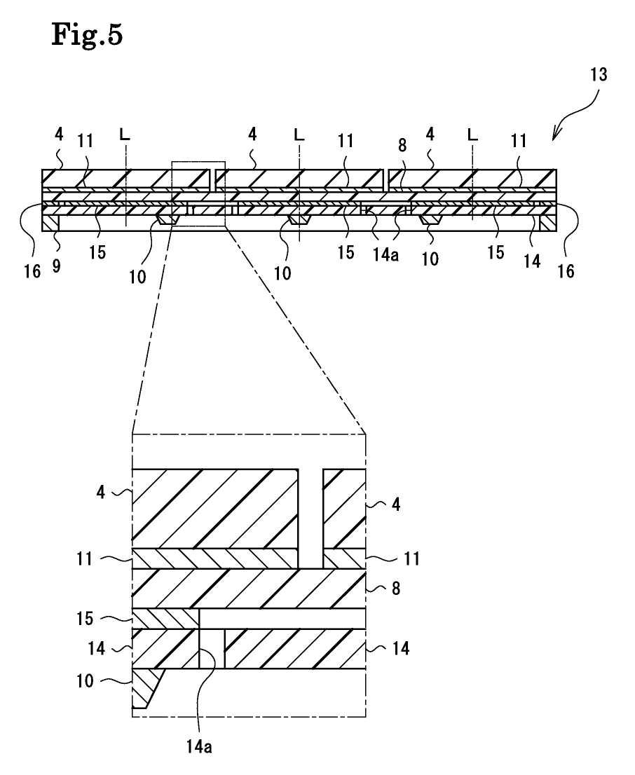

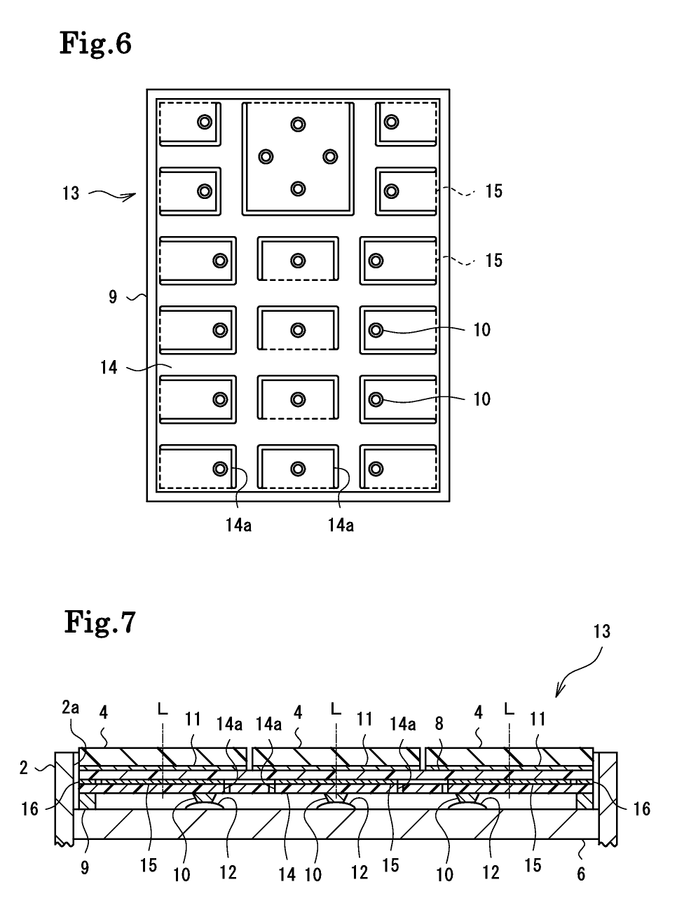

Second Embodiment (FIGS. 5 to 7): FIGS. 5 to 7 illustrate a key sheet 13 according to a second embodiment of the present invention. FIG. 5 is a sectional view of the key sheet 13. FIG. 6 is a bottom view of the key sheet 13. FIG. 7 is a sectional view illustrating a state in which the key sheet 13 is mounted to the mobile phone 1. The key sheet 13 differs from the key sheet 7 according to the above-mentioned embodiment in a configuration provided with a shape retaining sheet 14.

In the key sheet 13, while the key tops 4 are fixed on the front surface side of the base sheet 8, the shape retaining sheet 14 is fixed on the back surface side thereof through the intermediation of fixation layers 15, 16. Except for provision of the shape retaining sheet 14, the key sheet 13 has substantially the same configuration as that of the key sheet 7.

The shape retaining sheet 14 is a member for imparting a shape retaining property to the key sheet 13. The shape retaining sheet 14 is formed into a rectangular shape in plan view to have the outer edge equivalent to that of the key top group. That is, a size of the sheet surface of the shape retaining sheet 14 is the same as the size of the projection surface in the depressing direction of the key top group. In plan view, the key tops 4 cover the base sheet 8 and the shape retaining sheet 14, and the base sheet 8 and the shape retaining sheet 14 are provided so as to hide behind the key tops 4.

That is, fixation of the shape retaining sheet 14 to the base sheet 8 is effected by the fixation layers 15 having a rectangular shape slightly smaller than that of the key tops 4 and corresponding to the key tops 4, and the fixation layer 16 having a frame shape and corresponding to the outer edge of the base sheet 8.

Meanwhile, on the back surface of the shape retaining sheet 14, the truncated-cone shaped pushers 10 are formed and the frame-shaped elastic fixation portion 9 is formed along the outer edge of the shape retaining sheet 14.

In addition, in the shape retaining sheet 14, insulating holes 14a, which insulate stress acting in the sheet surface direction of the shape retaining sheet 14, are provided so as to pass through the shape retaining sheet 14 in the sheet thickness direction thereof. As illustrated in FIG. 6, each of the insulating holes 14a is formed into a C-shape or L-shape in plan view to surround two or three sides of each of the fixation layers 15 at the periphery thereof.

It is preferred that materials for the shape retaining sheet 14 be a hard resin film and a metal plate from the viewpoint of the requisite performance such as mechanical strength, durability, and reduction in weight. A thermoplastic resin and a reactive curing resin can be used as a hard resin film. Examples of the hard resin film include a polycarbonate resin film, a polymethyl methacrylate resin film, a polypropylene resin film, a polystyrene resin film, a polyacrylic copolymer resin film, a polyolefin resin film, an acrylonitrile-butadiene-styrene resin film, a polyester resin film, a polyurethane resin film, and a polyamide resin film. When the workability of those hard resin films is further taken into consideration, a polycarbonate resin film, a polymethyl methacrylate resin film, a polyacrylic copolymer resin film, and an acrylonitrile-butadiene-styrene resin film are preferred. When the transparency of those hard resin films, which is useful for forming into an illuminating key sheet, is taken into consideration, a polycarbonate resin film, a polymethyl methacrylate resin film, and a polyacrylic copolymer resin film are preferred. As a metal, a single metal or an alloy of stainless steel, aluminum, chromium, iron, gold, silver, copper, nickel, tin, and the like may be used. Of those metals, preferred are stainless steel, aluminum, gold, copper, and the like because those metals can easily be processed into a thin plate.

The base sheet 8 in this embodiment can be made of the same material as that for the base sheet 8 of the key sheet 7 described in the above-mentioned embodiment. However, the key sheet 13 is provided with the shape retaining sheet 14, and hence the softer base sheet 8 can be used and a material having no shape retaining property may be used.

The key sheet 13 is manufactured as follows. The molded key tops 4 are fixed onto the front surface of the base sheet 8 through the intermediation of the adhesive layers 11. Further, the shape retaining sheet 14 having the insulating holes 14a formed therein is fixed onto the back surface of the base sheet 8 through the intermediation of the fixation layers 15, 16. Then, after the pushers 10 are formed on the back surface of the shape retaining sheet 14, the elastic fixation portion 9 is stuck onto the back surface of the shape retaining sheet 14, and thus the key sheet 13 is obtained.

FIG. 7 illustrates a state in which the key sheet 13 thus obtained is assembled to the mobile phone 1.

Inside the casing 2 of the mobile phone 1, there is provided the circuit board 6 on which the belleville springs 12 are arranged, and the key sheet 13 fixed by the elastic fixation portion 9 is placed above the circuit board 6. Thus, a pushbutton switch is formed.

When the key tops 4 exposed through the operational opening 2a of the casing 2 are subjected to depressing operation, the entire base sheet 8 undergoes curving deformation and is deflected, and the pushers 10 depress the belleville springs 12 to thereby effect input.

In the key sheet 13, the same operation and effect as those of the key sheet 7 are exerted, and it is possible to retain the shape of the key sheet 13 even when the base sheet 8 is flexible and easily deformed, and it is possible to facilitate handling. The shape retaining sheet 14 is fixed to the base sheet 8 at the outer edge of the shape retaining sheet 14 by the fixation layer 16, and hence it is possible to retain the shape of the key sheet 13 by the entire surface of the shape retaining sheet 14. In addition, the base sheet 8 and the shape retaining sheet 14 are fixed to each other by the fixation layers 15 while corresponding to the key tops 4. Thus, even when the base sheet 8 is flexible and easily deformed, it is possible to suppress deflection phenomenon which occurs on the center side of the sheet. Note that, regarding the fixation layer 16, the double-faced tape used as the elastic fixation portion 9 can be used in place of the adhesive.

The shape retaining sheet 14 is provided with the insulating holes 14a for insulating stress in the surface direction of the shape retaining sheet 14, and hence it is possible to easily deflect the shape retaining sheet 14 in the depressing direction, and to decrease depression load. Therefore, when depressing the belleville springs 12 having a click feeling, it is possible to increase a click feeling.

Even when the shape retaining sheet 14 is provided with the insulating holes 14a as described above, the frame-shaped fixation layer 16 and the double-faced tape 9, which correspond to the outer edge of the base sheet 8, can exert a sealing property, and it is possible to prevent water and foreign matters from easily entering between the key sheet 13 and the circuit board 6.

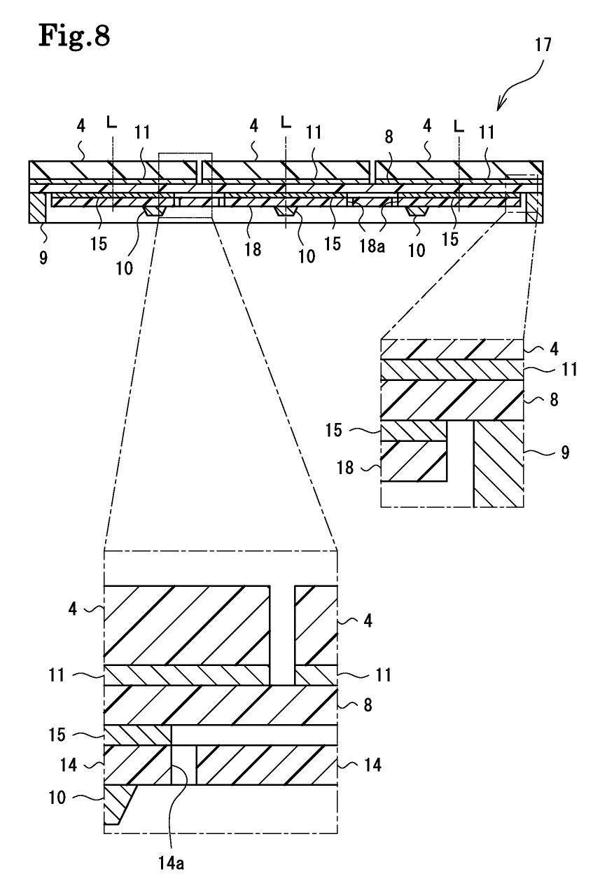

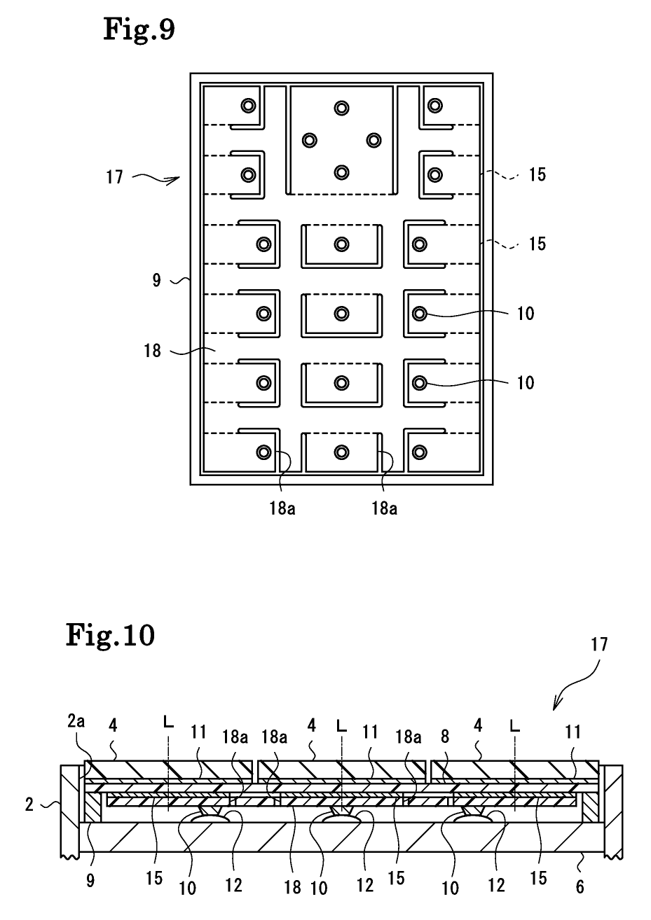

Third Embodiment (FIGS. 8 to 10): FIGS. 8 to 10 illustrate a key sheet 17 according to a third embodiment of the present invention. FIG. 8 is a sectional view of the key sheet 17. FIG. 9 is a bottom view of the key sheet 17. FIG. 10 is a sectional view illustrating a state in which the key sheet 17 is provided to the mobile phone 1. The key sheet 17 according to this embodiment differs from the key sheet 13 according to the above-mentioned embodiment in a configuration of a shape retaining sheet 18. The key sheet 17 is otherwise of the same configuration as that of the key sheet 13.

The shape retaining sheet 18 is formed into a rectangular shape smaller in size than the projection surface in plan view in the depth direction of the key top group. Thus, the shape retaining sheet 18 is fixed to the back surface of the base sheet 8 through the intermediation of the fixation layers 15, and the frame-shaped elastic fixation portion 9 is stuck to not the shape retaining sheet 18 but the outer edge of the base sheet 8. Accordingly, the truncated-cone shaped pushers 10 are formed on the back surface of the shape retaining sheet 18, and the elastic fixation portion 9 is not fixed thereto.

The shape retaining sheet 18 is also provided with insulating holes 18a for insulating stress in the sheet surface direction of the shape retaining sheet 18. As illustrated in FIG. 9, each of the insulating holes 18a is formed into a C-shape, L-shape, or the like in plan view at the periphery of the fixation layers 15.

In order to manufacture the key sheet 17, the key tops 4 are molded, and fixed onto the front surface of the base sheet 8 through the intermediation of the adhesive layers 11. Further, the fixation layers 15 are provided on the front surface of the shape retaining sheet 18 having the insulating holes 18a formed therein. Next, the shape retaining sheet 18 is fixed to the back surface of the base sheet 8 through the intermediation of the fixation layers 15. After the pushers 10 are formed on the back surface of the shape retaining sheet 18, the cut double-faced tape 9 is stuck to the back surface of the base sheet 8. Thus, the key sheet 17 is obtained.

As illustrated in FIG. 10, in the pushbutton switch of the mobile phone 1 provided with the key sheet 17 according to this embodiment, the key sheet 17 is assembled. That is, the key tops 4 are exposed through the operational opening 2a of the casing 2. The pushers 10 are provided so as to match the belleville springs 12. The base sheet 8 is fixed onto the circuit board 6 by the double-faced tape 9.

Further, when the key tops 4 are depressed, the entire base sheet 8 undergoes curving deformation and is deflected, and a part of the shape retaining sheet 18, which is surrounded by the insulating holes 18a corresponding to the key tops 4, is bent, and the pushers 10 depress the belleville springs 12 to thereby effect input.

In the key sheet 17, the elastic fixation portion 9 is provided to the outer edge on the back surface of the base sheet 8, and hence the shape retaining sheet 18 is not restrained by the elastic fixation portion 9 at the time of depressing operation. As a result, it is possible to reduce depression load.

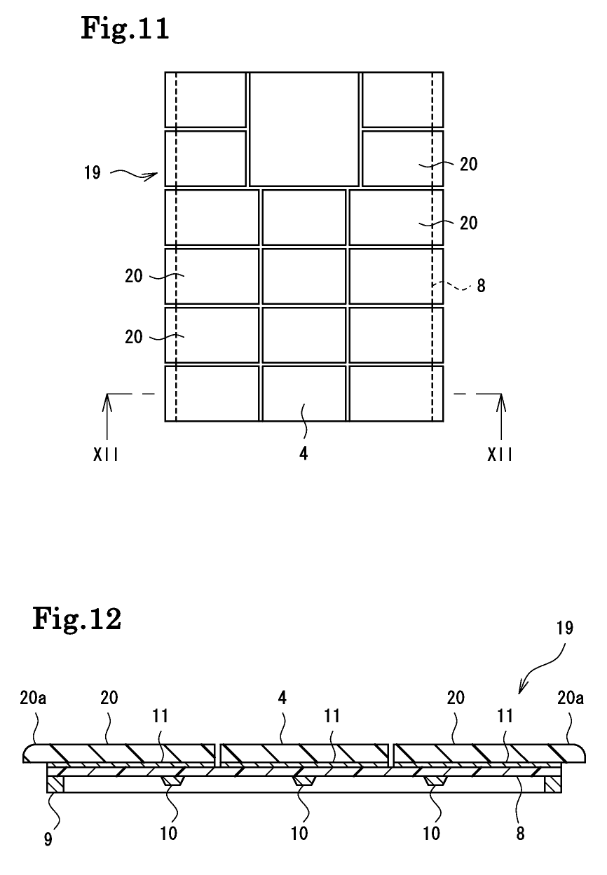

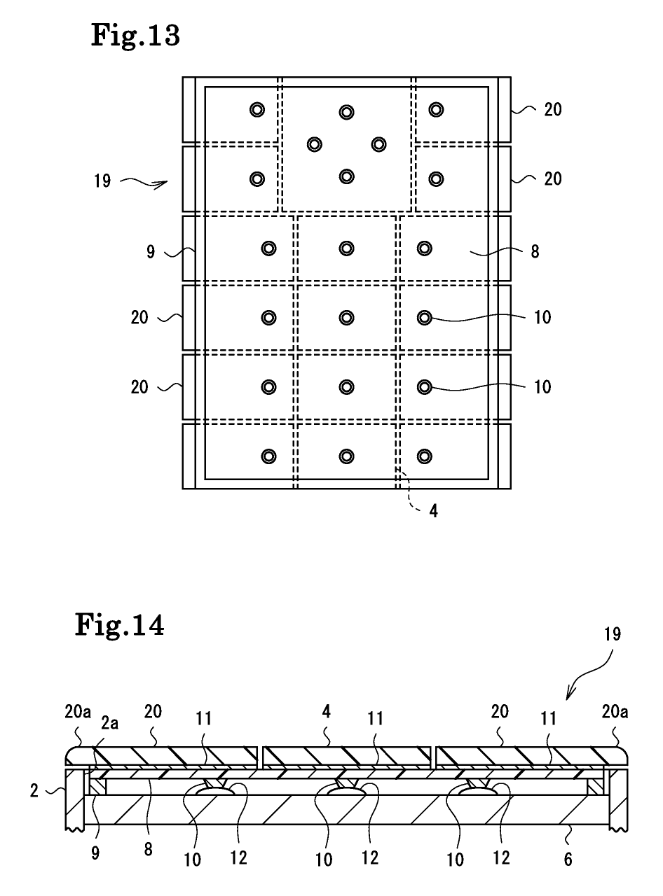

Fourth Embodiment (FIGS. 11 to 14): FIGS. 11 to 14 illustrate a key sheet 19 according to a fourth embodiment of the present invention. FIG. 11 is a plan view of the key sheet 19, and FIG. 12 is a sectional view of the key sheet 19 taken along the line XII-XII of FIG. 11. FIG. 13 is a bottom view of the key sheet 19, and FIG. 14 is a sectional view illustrating a state in which the key sheet 19 is assembled to the mobile phone 1. The key sheet 19 according to this embodiment differs from the key sheet 7 described above in a configuration provided with key tops 20. The key sheet 19 is otherwise of the same configuration as that of the key sheet 7.

Among the key tops 20, the key tops 20 in left and right two files of the key top group illustrated in FIG. 11 have, at one ends thereof, protrusions 20a protruding outward with respect to the end portion of the base sheet 8. The key tops 20 in the center file of the key top group are the same as the key tops 4 according to the first embodiment.

In order to manufacture the key sheet 19, the key tops 4, 20 are molded, and fixed onto the front surface of the base sheet 8 through the intermediation of the adhesive layers 11. After the pushers 10 are formed on the back surface of the base sheet 8, the elastic fixation portion 9 is stuck to the back surface of the base sheet 8. Thus, the key sheet 19 is obtained.

FIG. 14 illustrates a state in which the key sheet 19 thus obtained is assembled to the mobile phone 1.

Inside the casing 2 of the mobile phone 1, there is provided the circuit board 6 on which the belleville springs 12 are arranged, and the key sheet 19 fixed by the elastic fixation portion 9 is placed above the circuit board 6. Thus, a pushbutton switch is formed.

When the key tops 4, 20 exposed through the operational opening 2a of the casing 2 are subjected to depressing operation, the entire base sheet 8 undergoes curving deformation and is deflected, and the pushers 10 depress the belleville springs 12 to thereby effect input.

In the key sheet 19, the size of the front surface of the key top group can be made larger than the size of the sheet surface of the base sheet 8. As a result, it is possible to realize the key sheet 19 which facilitates depressing operation.

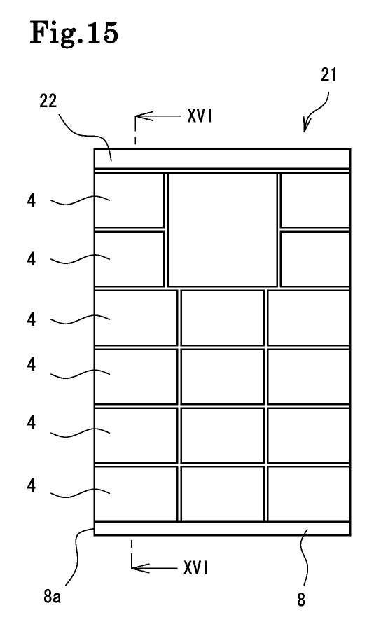

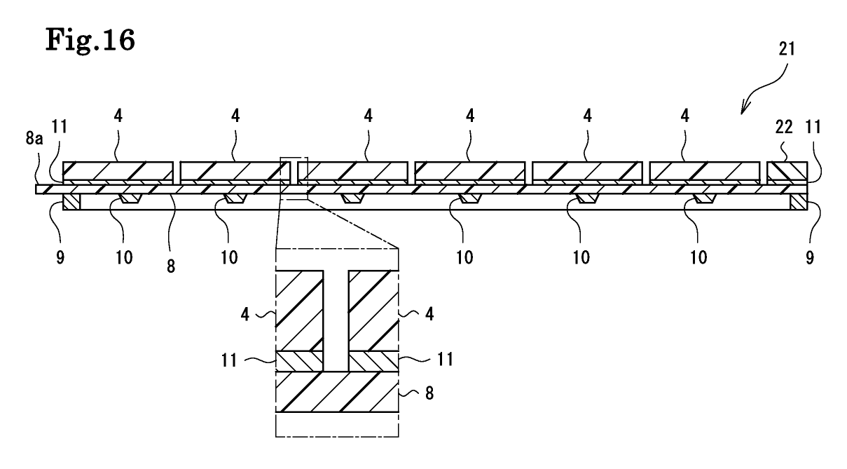

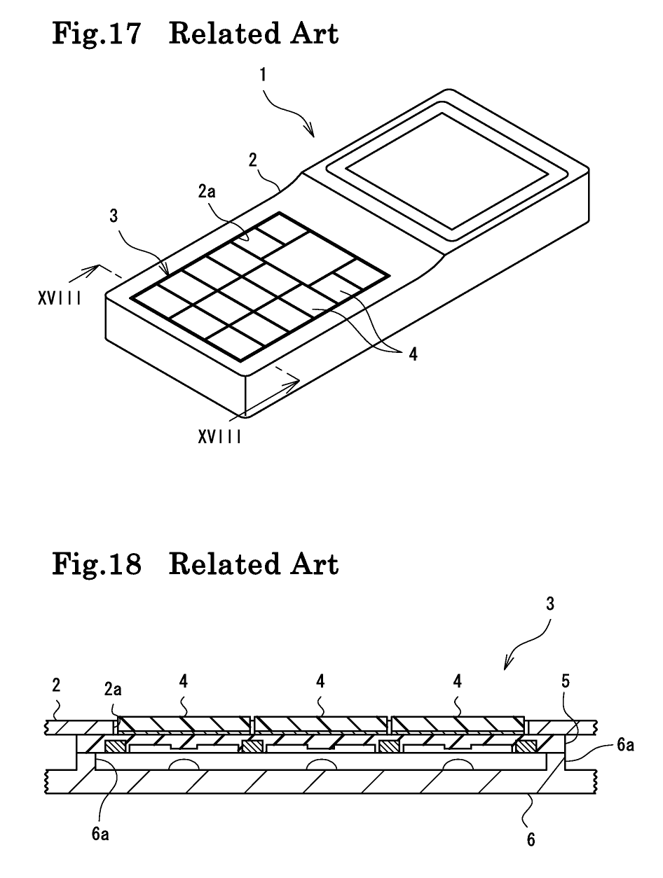

Fifth Embodiment (FIGS. 15 and 16): FIGS. 15 and 16 illustrate a key sheet 21 according to a fifth embodiment. FIG. 15 is a plan view of the key sheet 21, and FIG. 16 is a sectional view of the key sheet 21 taken along the line XVI-XVI of FIG. 15.

In FIG. 15, at the right and left ends of the key sheet 21, the key tops 4 cover the base sheet in the same way as that in other embodiments. However, at the upper end of the key sheet 21, a resin film 22 parallel to the key tops 4 forms an outer edge, and at the lower end thereof, the base sheet 8 has a protruding piece 8a protruding with respect to the key tops 4.

The resin film 22 appears on the front surface of the key sheet 21 through the operational opening 2a of the casing 2 of the mobile phone 1, and becomes a component of external appearance of the key sheet 21. As materials for the resin film 22, the materials used for the key tops 4, the materials used for the base sheet 8 and the shape retaining sheets 14, 18, and the like can be used through appropriate selection.

The key sheet 21 can be manufactured in the same way as that for the key sheets 7, 13, 17, and 19 described in other embodiments. The resin film 22 can be fixed onto the base sheet 8 in the same way as that for the key tops 4.

The key sheet 21 can be fixed, at the left and right ends thereof, to the circuit board 6 in the same way as that for the key sheets 7, 13, 17, and 19 described in other embodiments. However, at the lower end of the key sheet 21, the base sheet 8 has the protruding piece 8a, and hence fixation can be effected while the protruding piece 8a is sandwiched in the casing 2 and the like in the same way as that of the conventional technology. Further, at the upper end thereof, the resin film 22 forms the outer edge of the key sheet 21. Thus, when the key sheet 21 is assembled to the mobile phone 1, the key sheet 21 is positioned by abutting the resin film 22 against the casing 2 and the like, to thereby be placed on and assembled to the circuit board 6.

Another Modification: The key tops 20 according to the fourth embodiment can be applied to the key sheets 13, 17, and 21 according to the second embodiment, third embodiment, and fifth embodiment.

Further, in the key sheet 21 according to the fifth embodiment, at the left end and right end thereof illustrated in FIG. 15, the key tops form the outer edge. However, the present invention is not limited thereto, and regions of the key tops forming the outer edge, such as the upper end and lower end of the key sheet and the left and right ends and the lower end thereof, can be appropriately changed.

### EXAMPLE

First Example: Key tops (4) made of polycarbonate resin having a thickness of 0.4 mm are molded by injection molding. After decorating their front surfaces by print-forming display elements such as characters, symbols, etc., adhesive layers (11) formed of a hot-melt adhesive are laminated to the entire back surfaces of the key tops (4). Meanwhile, a base sheet (8) is obtained by cutting a hard polyurethane resin film having a thickness of 0.05 mm, and the key tops (4) are heat-fixed onto the front surface of the base sheet (8). Further, pushers (10) made of ultraviolet-curing acrylic liquid resin are formed on the back surface of the base sheet (8). Finally, a double-faced tape, which has a thickness of 0.4 mm and is formed of a base portion of a urethane foam layer and an acrylic pressure-sensitive adhesive layer, is stuck to the back surface of the base sheet (8) so as to be formed into a frame shape. As a result, an elastic fixation portion (9) is obtained. Thus, a key sheet (7) according to the first example is manufactured.

Second Example: Similarly to the first example, the key tops (4) are molded, and the adhesive layers (11) are applied to the key tops (4). The key tops (4) are fixed onto the front surface of the base sheet (8) formed of a soft polyurethane resin film having a thickness of 0.05 mm. Meanwhile, on a shape retaining sheet (14) which is formed of a hard polyethylene terephthalate resin film having a thickness of 0.05 mm and has insulating holes (14a) formed therein, fixation layers (15, 16) formed of an ultraviolet-curing adhesive are provided, and then the shape retaining sheet (14) is fixed to the back surface of the base sheet (8). The same pushers (10) as those in the first example are formed on the back surface of the shape retaining sheet (14), and the double-faced tape is stuck to the back surface of the shape retaining sheet (14) in the same way as that in the first example. As a result, the elastic fixation portion (9) is obtained. Thus, a key sheet (13) according to the second example is manufactured.

Third Example: Similarly to the first example, the key tops (4) are molded, and the adhesive layers (11) are applied to the key tops (4). The key tops (4) are fixed onto the front surface of the base sheet (8) formed of a soft polyurethane resin film having a thickness of 0.05 mm. Meanwhile, on a shape retaining sheet (14) which is made of stainless steel having a thickness of 0.05 mm and has insulating holes (14a) formed therein, fixation layers (15, 16) formed of a moisture-curing adhesive are provided, and then the shape retaining sheet (14) is fixed to the back surface of the base sheet (8). The same pushers (10) as those in the first example are formed on the back surface of the shape retaining sheet (14), and the double-faced tape is stuck to the back surface of the shape retaining sheet (14) in the same way as that in the first example. As a result, the elastic fixation portion (9) is obtained. Thus, a key sheet (13) according to the third example is manufactured.

Fourth Example: Similarly to the first example, the key tops (4) are molded, and the adhesive layers (11) are applied to the key tops (4). The key tops (4) are fixed onto the front surface of the base sheet (8) formed of a soft polyurethane resin film having a thickness of 0.05 mm. Meanwhile, on a shape retaining sheet (18) which is formed of a hard polyethylene terephthalate resin film having a thickness of mm and has insulating holes (18a) formed therein, fixation layers (15, 16) formed of an ultraviolet-curing adhesive are provided, and then the shape retaining sheet (18) is fixed to the back surface of the base sheet (8). The same pushers (10) as those in the first example are formed on the back surface of the shape retaining sheet (18), and the double-faced tape is stuck to the back surface of the base sheet (8) in the same way as that in the first example. As a result, the elastic fixation portion (9) is obtained. Thus, a key sheet (17) according to the fourth example is manufactured.

What is claimed is:

1. A key sheet which is mounted on a circuit board having a contact switch so as to serve as a pushbutton switch, comprising:
a plurality of key tops which are subjected to depressing operation in a depth direction in plan view; and
a base sheet which is flexible and on which the plurality of key tops are placed,
wherein the plurality of key tops are provided so that the plurality of key tops cover the base sheet and the base sheet hides behind the plurality of key tops in plan view at an outer edge on at least one end side of the key sheet, and
wherein an elastic fixation portion to be fixed to the circuit board is provided on a back surface side of the base sheet.

2. A key sheet according to claim 1, wherein a pusher for depressing the contact switch correspondingly to at least one of the plurality of key tops situated on the one end side of the key sheet is provided near a center of the base sheet while being shifted from a center of the at least one of the plurality of key tops.

3. A key sheet according to claim 1, wherein the elastic fixation portion is formed of a double-faced tape, which has adhesiveness on its front surface and includes a foam layer as a base portion.

4. A key sheet according to claim 1, wherein the elastic fixation portion is formed along an outer edge of the base sheet into a frame shape.

5. A key sheet according to claim 1, wherein a shape retaining sheet which is made of hard resin and suppresses deflection of the base sheet is provided on a back surface of the base sheet.

6. A key sheet according to claim 1, wherein the key tops have, at one end thereof, a protrusion protruding outward with respect to an end portion of the base sheet.

7. A key sheet according to claim 1, wherein a resin film parallel to the plurality of key tops constitutes one part of the outer edge of the key sheet, and at another part of the outer edge thereof, the base sheet has a protruding piece protruding outward with respect to the plurality of key tops.

8. A key sheet according to claim 5, wherein insulating holes, which insulate stress acting in a surface direction of the shape retaining sheet, are formed in the shape retaining sheet so as to pass through the shape retaining sheet in a sheet thickness direction thereof.
